(19) United States
(12) Patent Application Publication
(10) Pub. No.: US 2005/0282413 A1
(43) Pub. Date: Dec. 22, 2005

(54) Small form factor pluggable module providing passive optical signal processing of wavelength division multiplexed signals

(76) Inventors: Frederick S. Israel, Fairfield, CT (US); Jonathan Reeves, Cheshire, CT (US)

Correspondence Address: GORDON & JACOBSON, P.C., 60 LONG RIDGE ROAD, SUITE 407, STAMFORD, CT, 06902, US

(21) Appl. No.: 11/157,738

(22) Filed: Jun. 21, 2005

Related U.S. Application Data
(60) Provisional application No. 60/581,537, filed on Jun. 21, 2004.

(51) Int. Cl. H01R 12/00

(52) U.S. Cl. 439/76.1

(57) ABSTRACT

An optical network device is provided having a small form factor pluggable housing with a maximum width dimension not greater than 31 mm (i.e., the width of a GBIC module). The housing supports an optical subsystem and an electrical interface. The optical subsystem provides passive optical processing of wavelength division multiplexed optical signals. The electrical interface communicates electrical signals to a host system operably coupled thereto. The electrical signals carry data to the host system, which preferably includes module identification data (e.g., a manufacturer name; a part number; and a serial number of the device) and/or operational parameter data (e.g., wavelengths that are multiplexed, demultiplexed, added, dropped by the optical subsystem). The interfaces of the device (i.e., connectors and fiber optic pigtails) as well as the functionality of the optical subsystem can readily be adapted for different applications and network configurations. In the preferred embodiment, the optical device is a GBIC module for CWDM applications; however, it can be readily adapted to smaller form factor designs (such as SFP and XFP) and for other WDM applications (such as DWDM).

### CROSS-REFERENCE TO RELATED APPLICATIONS

This application claims benefits from U.S. Provisional Patent Application No. 60/581,537 filed Jun. 21, 2004, the contents of which are hereby incorporated herein by reference.

### BACKGROUND OF THE INVENTION

1. Field of the Invention

This invention relates broadly to optical communication systems. More particularly, this invention relates to small form factor pluggable modules that are part of optical communication systems.

2. State of the Art

Optical communication devices have become an important part of modern communication systems. In such systems, optical signals are carried over fiber optic lines, and optical transceiver modules are used convert electrical signals to optical signals and to convert optical signals to electrical signals. Industry standards have been established to define the physical interface parameters of the modules. These standards permit the interconnection of different devices manufactured by different manufacturers without the use of adapter assemblies.

One of these industry standards is referred to as the Giga-bit Interface Converter standard (or GBIC standard). The GBIC standard, which is herein incorporated by reference in its entirety, is available for download at ftp://ftp.seagate.com/sff/SFF-8053.PDF. Modules that conform to the GBIC standard are referred to as GBIC modules. These modules generally have a length from the end of the connector to its insertion stop point of 57.15 mm, an overall height of 12.01 mm, a width of 30.48 mm as well as a guide slot and retention latch mechanism to thereby provide a pluggable small form factor module that is readily interfaced to a host system. Follow-on industry standards have been promulgated for yet smaller modules, including standards for SFP and XFP modules.

In modern CWDM optical networks as well as modern DWDM optical networks, the GBIC modules and SFP modules used in such networks are active optical transceivers. The optical transceivers are active in that they utilize opto-electrical components in carrying out the desired optical signal transmission and optical signal receiving operations. In contrast, the passive optical add/drop multiplexing functionality and the passive optical multiplexing and demultiplexing functionality of such networks are provided by large and expensive rack-mount modules. Patch cables are also used for passive add/drop multiplexing. Both of these options are disadvantageous in that it is difficult to ascertain and control the physical connections to/from such modules and the inventory of wavelengths carried over the connections. Typically, a color code scheme is assigned to the wavelengths of the optical network and the appropriate colors painted on or affixed to the physical connections to/from such modules. This inventory control scheme is time consuming and difficult to manage as one must physically inspect the connections and/or modules to ascertain and/or verify the network configuration. As the network evolves over time, this requirement becomes increasingly burdensome.

Thus, there remains a need in the art for small form factor pluggable modules that provide for passive optical add/drop multiplexing functionality and/or the passive optical multiplexing and demultiplexing functionality, and that allows for more efficient and effective inventory control and network configuration verification.

### SUMMARY OF THE INVENTION

It is therefore an object of the invention to provide a small form factor pluggable modules that provides for passive optical add/drop multiplexing functionality and/or passive optical multiplexing and demultiplexing functionality.

It is another object of the invention to provide such a small factor pluggable module that provides for more efficient and effective inventory control and network configuration verification.

It is a further object of the invention to provide different small factor pluggable modules that are suitable for various network configurations.

In accord with these objects, which will be discussed in detail below, an optical network device is provided having a small form factor pluggable housing with a maximum width dimension not greater than 31 mm (i.e., the width of a GBIC module). The housing supports an optical subsystem and an electrical interface. The optical subsystem provides passive optical processing of wavelength division multiplexed optical signals. The electrical interface communicates electrical signals to a host system operably coupled thereto. The electrical signals carry data to the host system, which preferably includes module identification data (e.g., a manufacturer name; a part number; and a serial number of the device) and/or operational parameter data (e.g., wavelengths that are multiplexed, demultiplexed, added, dropped by the optical subsystem). Such data is useful in maintaining knowledge of and control over the capabilities of the module as part of the host system. It can readily be accessed by the host system and communicated electronically to a network management system for more efficient and effective inventory control and network configuration verification.

The interfaces of the module (i.e., connectors and fiber optic pigtails) as well as the functionality of the optical subsystem can readily be adapted for different applications and network configurations, such as multi-channel multiplexing and demultiplexing over two unidirectional optical fiber links or over a single bidirectional optical fiber link, single-channel optical add/drop multiplexing over two unidirectional optical fiber links or over two bidirectional optical fiber links, and two-channel optical add drop multiplexing over two optical fiber links.

In the preferred embodiment, the optical device is a GBIC module. However, the principles of the present invention can readily be applied to smaller form factor designs, such as SFP and XFP. Moreover, the principles of the present invention can be readily applied to CWDM and DWDM applications.

Additional objects and advantages of the invention will become apparent to those skilled in the art upon reference to the detailed description taken in conjunction with the provided figures.

### BRIEF DESCRIPTION OF THE DRAWINGS

FIG. 1A is a perspective view of an exemplary small form factor pluggable module in accordance with the present invention wherein the passive optical signal processing part of FIG. 2A is mounted to the housing of FIGS. 3-7.

FIG. 1B is a functional block diagram of the small form factor pluggable module of FIG. 1A in accordance with the present invention.

FIG. 2A is a perspective view of the passive optical signal processing part of the small form factor pluggable module of FIG. 1A.

FIG. 2B is a schematic exploded view of the passive optical signal processing part of FIG. 2A.

FIG. 3 is a perspective view of the housing of the small form factor pluggable module of FIG. 1A.

FIG. 4 is a top view of the housing of FIG. 3.

FIG. 5 is a bottom view of the housing of FIG. 3.

FIG. 6 is a front view of the housing of FIG. 3.

FIG. 7 is a side view of the housing of FIG. 3.

FIG. 8 is a perspective view of an alternate housing for a small form factor pluggable module in accordance with the present invention.

FIG. 9 is another perspective view of the housing of FIG. 8.

FIG. 10 is a top view of the housing of FIG. 8.

FIG. 11 is a bottom view of the housing of FIG. 8.

FIG. 12 is a front view of the housing of FIG. 8.

FIG. 13 is a side view of the housing of FIG. 8.

FIG. 14A is a perspective view of an alternate embodiment of a small form factor pluggable module in accordance with the present invention.

FIG. 14B is a functional block diagram of the small form factor pluggable module of FIG. 14A in accordance with the present invention.

FIG. 15A is a perspective view of another embodiment of a small form factor pluggable module in accordance with the present invention.

FIG. 15B is a functional block diagram of the small form factor pluggable module of FIG. 15A in accordance with the present invention.

FIG. 15C is a functional block diagram of yet another embodiment of a small form factor pluggable module in accordance with the present invention.

FIG. 15D is a functional block diagram of another embodiment of a small form factor pluggable module in accordance with the present invention.

FIG. 16 is a perspective view of 4-way female LC connector that may be integrated as part of the housing of a small form factor pluggable module in accordance with the present invention.

### DETAILED DESCRIPTION

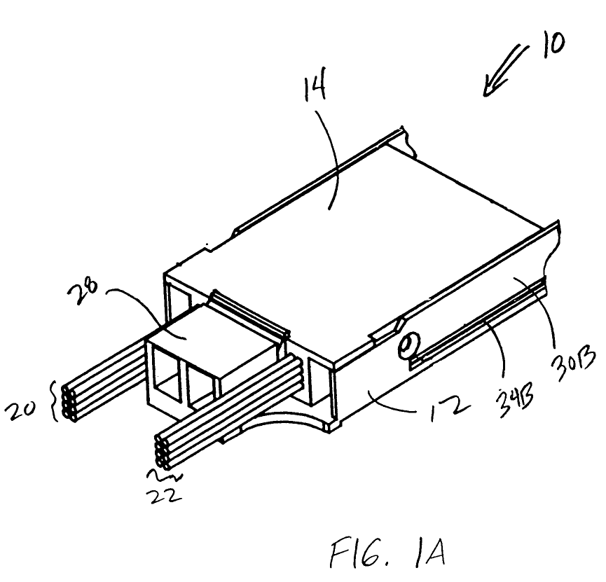

Turning now to FIGS. 1A and 1B, there is shown a small form factor pluggable module 10 in accordance with the present invention, including a housing 12 and a passive optical signal processing part 14 that is mounted to the housing 12. The passive optical signal processing part 14 provides wavelength division multiplexing and demultiplexing of optical signals. Wavelength Division Multiplexing (WDM) is a technology that allows the transmission of data with different wavelengths on the same fiber optic line simultaneously whereby increasing overall transmission capacity. Such technology maximizes the use of existing optical infrastructure and removes bandwidth bottle necks with out deploying new fiber infrastructure. WDM technology is logically partitioned into Course WDM (CWDM) and Dense WDM (DWDM). In general, CWDM supports up to 16 wavelengths and uses the ITU standard 20 nm spacing between wavelengths, from 1310 nm to 1610 nm. DWDM supports up to 64 wavelength and uses the ITU standard 100 GHz or 200 GHz spacing between wavelengths, from 1500 nm to 1600 nm.

The module 10 has a maximal width of 1.197 inches (30.4 mm) and a maximal height of 0.411 inches (10.4 mm) such that it conforms to the GBIC standard.

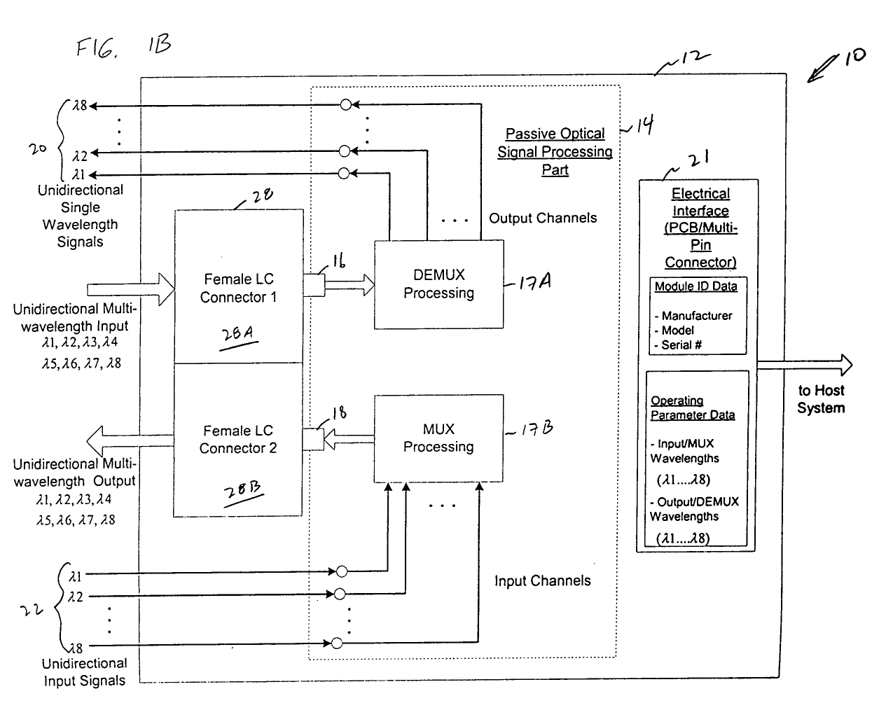

As shown in FIGS. 1A, 1B and 2A, the housing 12 supports a duplex female LC connector 28, which has a first female LC connector part 28A and a second female LC connector part 28B. The housing 12 (including the duplex female LC connector 28) is preferably realized as a one-piece unitary part by die-casting aluminum, injection molding plastic or other suitable manufacturing techniques. The first female LC connector part 28A is aligned to a multi-wavelength input port 16 of the passive optical signal processing part 14. The second female LC connector part 28B is aligned to a multi-wavelength output port 18 of the passive optical processing part 14.

The first connector part 28A and the multi-wavelength input port 16 receive a unidirectional input multi-wavelength optical signal (i.e., a plurality of wavelength division multiplexed optical signals, for example 8 CWDM wavelengths labeled λ1, λ2, λ3, λ4, λ5, λ6, λ7, and λ8) that is supplied by an “input” fiber optic link that is coupled thereto by a male LC optical fiber connector (not shown). The multi-wavelength output port 18 and the second connector part 28B output a unidirectional output multi-wavelength optical signal (i.e., a plurality of wavelength division multiplexed optical signals, for example the 8 CWDM wavelengths labeled λ1, λ2, λ3, λ4, λ5, λ6, λ7, and λ8) for transmission over an “output” fiber optic link that is coupled thereto by a male LC optical fiber connector (not shown). The optical part 14 also includes a set of unidirectional output fiber pigtails 20 that each carry a different single-wavelength optical signal (i.e., one of the 8 CWDM wavelengths λ1, λ2, λ3, λ4, λ5, λ6, λ7, and λ8) that is part of the input multi-wavelength optical signal received at the first connector part 28A and input port 16. The optical part 14 also includes a set of unidirectional input fiber pigtails 22 that each carry a different single-wavelength optical signal (i.e., one of the 8 CWDM wavelengths λ1, λ2, λ3, λ4, λ5, λ6, λ7, and λ8) that is part of the output multi-wavelength optical signal output by the output port 18 and the second connector part 28B.

The passive optical signal processing part 14 includes optical filter elements (labeled DEMUX Processing 17A) that are mounted onto a support block (e.g., a polymer bench) and function to demultiplex the input multi-wavelength optical signal received at the first input port 16 into its discrete wavelength component signals and direct such wavelength component signals to the output fiber pigtails 20. The passive optical signal processing part 14 also includes elements (labeled MUX Processing 17B) that are mounted onto a support block (e.g., a polymer bench) and function to multiplex together the discrete wavelength component optical signals received over the input fiber pigtails 22 to form a corresponding output multi-wavelength optical signal and direct the output multi-wavelength optical signal to the multi-wavelength output port 18 for output therefrom. Examples of the elements that carry out such passive optical demultiplexing and multiplexing operations is described in detail in International Patent Publication WO 03/028262, published on Apr. 3, 2003; International Patent Publication WO 2004/044633, published on May 27, 2004; U.S. Pat. No. 6,008,920, issued on Dec. 28, 1999; U.S. Pat. No. 6,292,298, issued on Sep. 18, 2001; and U.S. Pat. No. 5,859,717, issued on Jan. 12, 1999, herein incorporated by reference in their entirety.

The optical part 14 is passive in that it does not utilize any opto-electrical components in carrying out the desired optical multiplexing and demultiplexing operations. The dimensions of the optical part 14 is designed such that it readily fits inside the internal compartment of the housing 12 as best shown in FIG. 1A.

The small form factor pluggable module 10 is intended to fit within a slot in a host system (not shown). The housing 12 of the module 10 supports an electrical interface 21 that stores module identification data as well as operational parameter data, and communicates such data to the host system. The module identification data preferably includes data that identifies the manufacturer, model, and/or serial number of the module 10. The operational parameter data includes data that identifies the operational characteristics of the module 10, such as the wavelengths (e.g., λ1, λ2, λ3, λ4, λ5, λ6, λ7, and λ8) that are supported by the demultiplexing operations of the optical part 14 as well as the wavelengths (e.g., λ1, λ2, λ3, λ4, λ5, λ6, λ7, and λ8) that are supported by the multiplexing operations of the optical part 14. Such data is useful in maintaining knowledge of and control over the capabilities of the module 10 as part of the host system. It can readily be accessed by the host system and communicated electronically to a network management system for more efficient and effective inventory control and network configuration verification.

Preferably, the electrical interface 21 is realized by a printed circuit board and a multi-pin connector. The printed circuit board includes read-only memory and interface circuitry. The read-only memory stores the module identification data as well as the operational parameter data. The interface circuitry accesses the data stored in the read-only memory and communicates such data to the host system over the multi-pin connector. The interface circuitry preferably supports a common communication protocol, such as the I²C bus protocol, the RS-232 serial communication protocol, and the 10/100 ethernet protocol, or other well known protocols. The interface circuitry may also support common network management protocols such as SNMP. In SNMP, the module identification data as well as the operational parameter data is stored in a Management Information Base (or MIB) that is accessed by the interface circuitry in response to SNMP messages communicated thereto from the host system. Minimal bandwidth is required for the transfer of the module identification data as well as the operational parameter data between the module 10 and the host system. Because the optical signal processing carried out by the module 10 is passive, the significant bandwidth requirements typically required for optical transceiver modules are avoided. Thus, the communication link provided by the electrical interface 21 of the module can be an inexpensive low-bandwidth link, such as an I²C link, the RS-232 link or 10/100 ethernet link discussed above.

FIG. 2B illustrates an exploded schematic view of an exemplary embodiment of the optical part 14 of FIG. 2A. It includes a bottom cage 201 and top cage (not shown) that define an interior cavity. The elements that provide the multiplexing and demultiplexing functionality of mounted on one or more support blocks as part of a passive optical signal processing subsystem 203 that is mounted within the interior cavity. The output fiber pigtails 20 and the input fiber pigtails 22 (not shown) are coupled to the passive optical signal processing subsystem 203 through respective access ports 205. A ceramic ferrule 207 is held in place by a cutout portion 209 in the bottom and top cages. The ceramic ferrule 207 provides the multi-wavelength input port 16. A second ferrule (not shown) is provided for the multi-wavelength output port 18. The ferrules are sized and positioned such that they lie substantially at the respective centers of the first female LC connector 28A and the second female LC connector 28B. In this manner, optical loss is limited at the duplex LC connector 28.

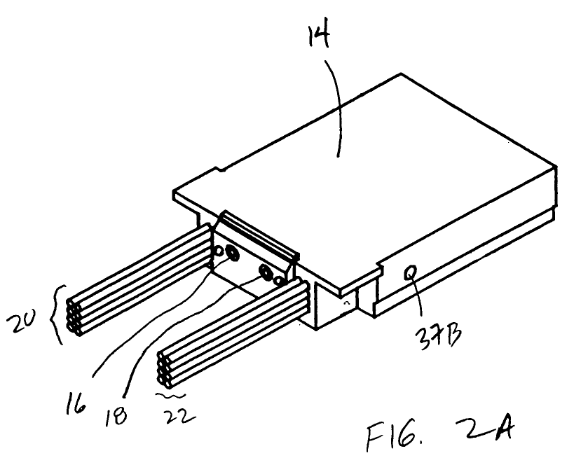

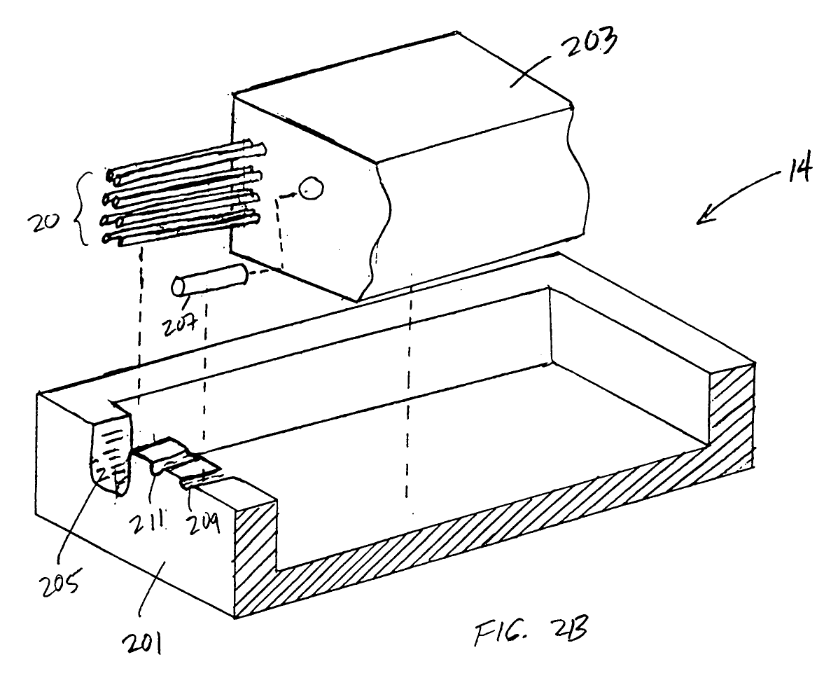

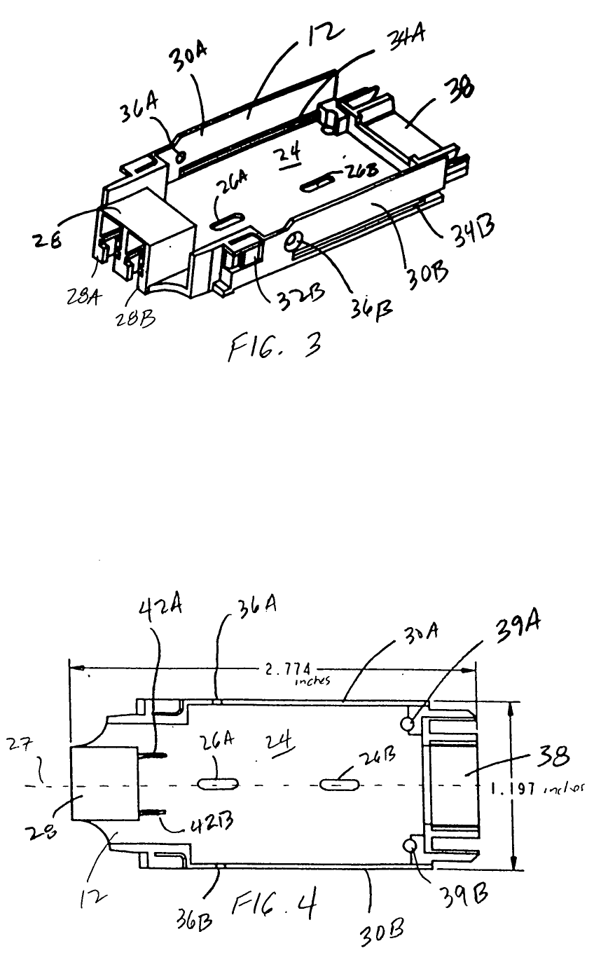

FIGS. 3 through 7 illustrate the housing 12 of the module 10, which includes a bottom plate 24 with two slots 26A, 26B which are disposed along the central axis 27 of the housing 12. Mounting screws (not shown) pass through the two slots 26A, 26B and attach to the bottom surface of the optical part 14 to provide for attachment and alignment of optical part 14 with respect to the housing 12. The duplex female LC connector 28 is integrated onto the front of the bottom plate 24 as best shown in FIGS. 3 and 4. Two sidewalls 30A, 30B project vertically from the edges of the bottom plate 24 as best shown in FIG. 3. The two sidewalls 30A, 30B include respective latch mechanisms 32A, 32B with release tabs as are well known. The sidewalls 30A, 30B also include respective guide slots 34A, 34B that allows for guided pluggable insertion of the module into the host system as is well known. Finally, the sidewalls 30A, 30B include respective screw holes 36A, 36B. Mounting screws (not shown) pass through the two holes 36A, 36B and attach to the respective holes (shown as 37B in FIG. 2) in the side surface of the optical part 14 to provide for attachment and alignment of optical part 14 with respect to the housing 12. The top surface of the optical part 14 provides the top surface of the module 10 as shown in FIG. 1A.

A back connector assembly 38 is integrally formed with the bottom plate 24 (or affixed thereto). The back connector assembly 38 supports the electrical interface 21 (e.g., printed circuit board and multi-pin connector) as described above. A cover (not shown) covers the back connector assembly 38 and the electrical interface 21 supported thereon. The cover is affixed to the back connector assembly 38 by screws that pass through screw holes 39A, 39B and screw into corresponding holes therein.

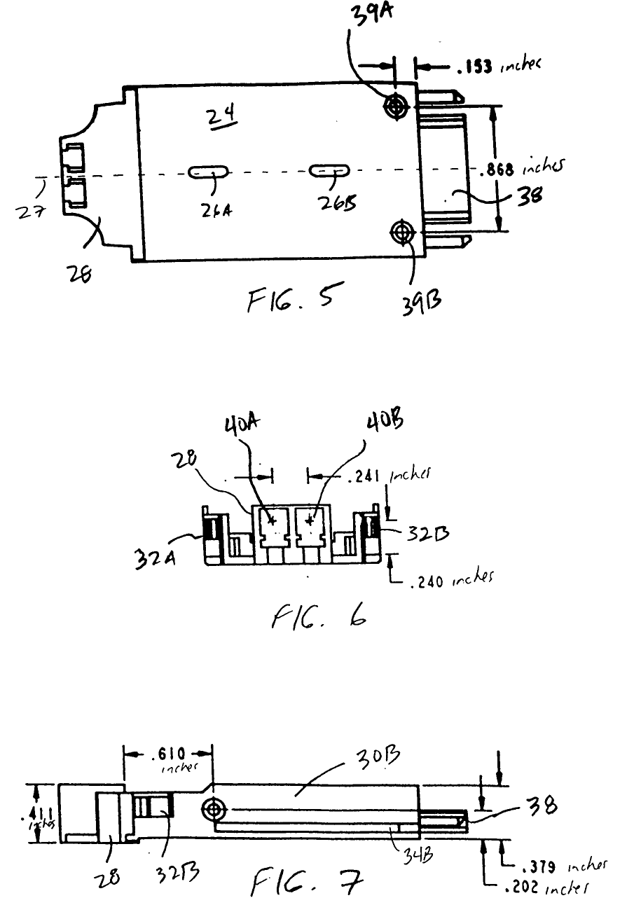

For reduced insertion loss, the optical part 14 must be precisely aligned to the duplex female LC connector 28 such that the central axes of the input port 16 and output port 18 (e.g., ferrules 207) of the optical part 14 are aligned to the respective centers of the duplex female LC connector 28 (labeled 40A, 40B in FIG. 6). Such precise alignment can be aided by a pair of pins 42A, 42B that project rearward from the connector 28 as shown in FIG. 4. The pins 42A, 42B fit into alignment ports in the optical part 14. Such alignment ports are formed by cutouts (one shown as 211) in the top and bottom cage of the optical subsystem 203 in the exemplary embodiment of FIG. 2B. The pins 42A, 42B are positioned adjacent the input port 16 and output port 18 (e.g., ferrules 207). In this manner, the input port 16 and output port 18 (e.g., ferrules 207) are precisely aligned to the centers of the connector 28 and insertion loss is reduced. In an alternate embodiment, precise alignment of the optical part 14 to the connector 28 can be accomplished by exchanging the location of the pins 42A, 42B and alignment ports whereby the pins project forward from the front of the optical part 14 to mate with alignment ports in the connector 28.

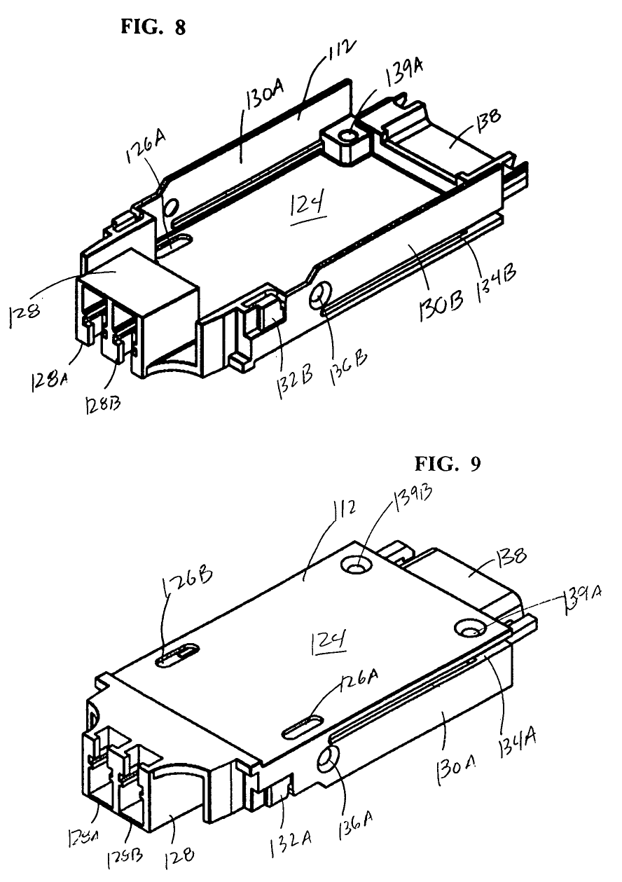

As best shown in FIG. 4, the housing 12 has a total length of total length of 2.774 inches (70.4 mm) and a maximal width of 1.197 inches (30.4 mm). As best shown in FIG. 7, the walls 30A, 30B of the housing 12 have a maximal height of 0.379 inches (9.6 mm), and the duplex female LC connector 28 has a height of 0.411 inches (10.4 mm). In this manner, the width and height dimensions of the module 10 conform to the GBIC standard.

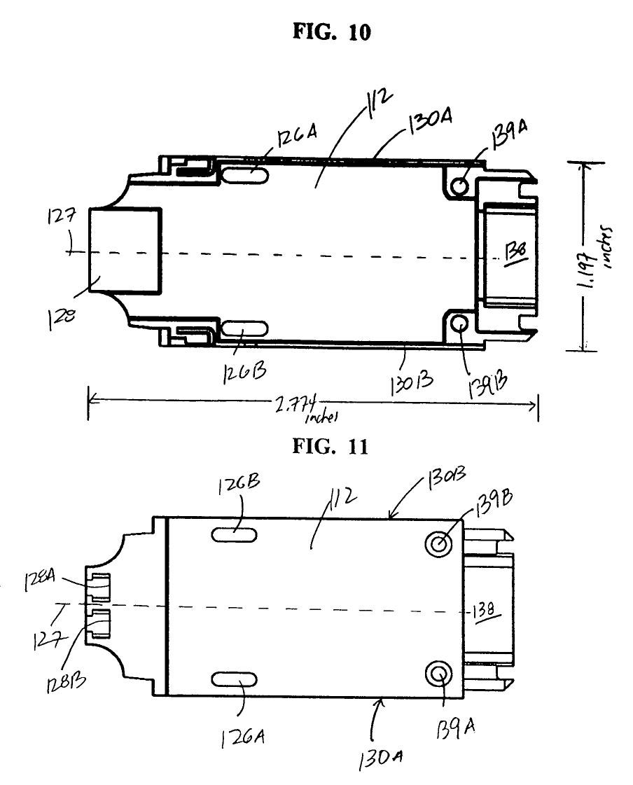

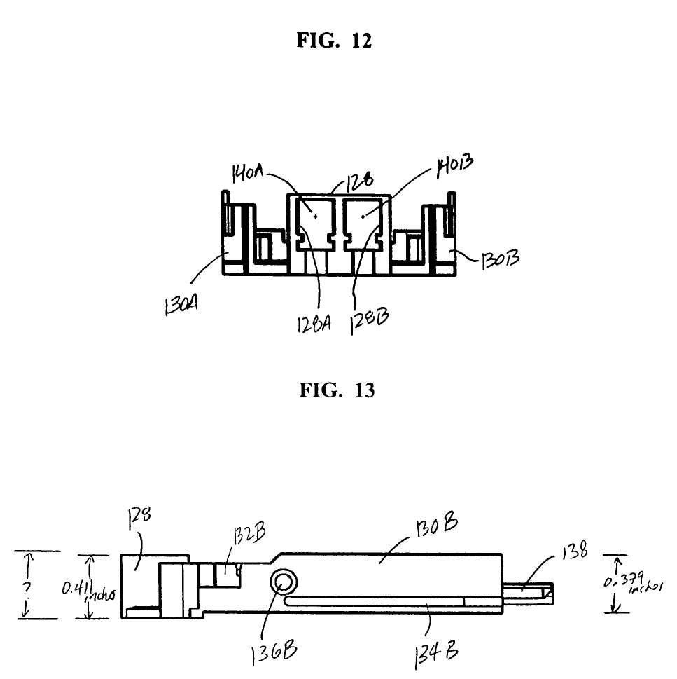

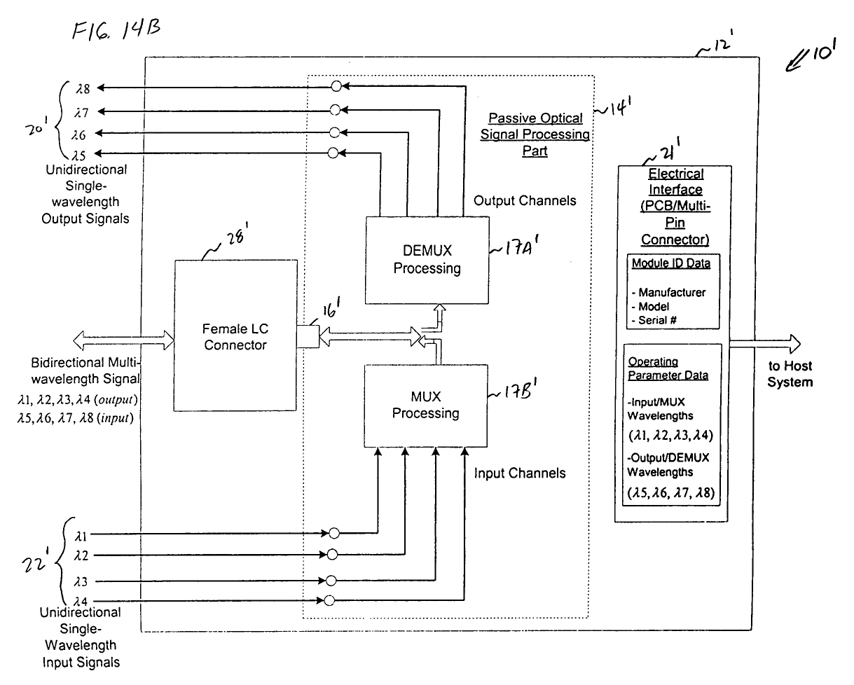

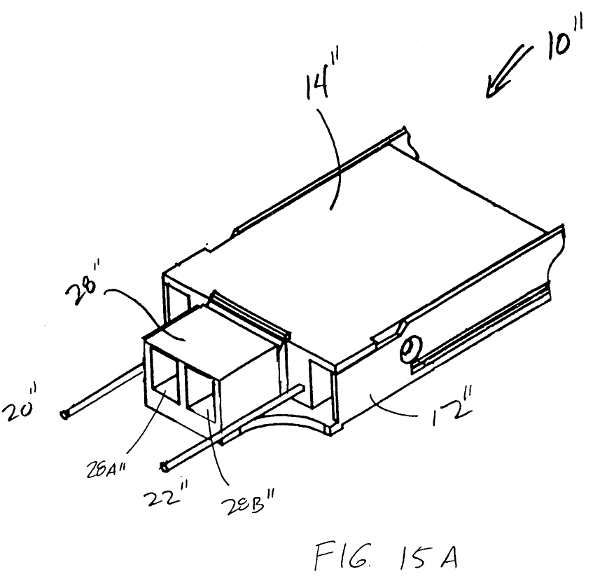

FIGS. 8 through 13 illustrate an alternate housing 12′ for use as part of the small form factor pluggable modules described herein, which includes a bottom plate 24 with two slots 26A′, 26B′ that are mounted opposite one another relative to the central axis 27 adjacent the sidewalls 30A, 30B. Mounting screws (not shown) pass through the two slots 26A′, 26B′ and attach to the bottom surface of the optical part 14 to provide for attachment and alignment of optical part 14 with respect to the housing 12. The duplex female LC connector 28 is integrated onto the front of the bottom plate 24 as best shown in FIGS. 8, 9 and 10. The two slots 26A′, 26B′ provide alignment such that the central axes of the input port 16 and output port 18 (e.g., ferrules 207) of the optical part 14 are aligned to the respective centers of the duplex female LC connector 28 (labeled 40A, 40B in FIG. 12). In this manner, insertion loss is reduced.

The sidewalls 30A, 30B project vertically from the edges of the bottom plate 24. The two sidewalls 30A, 30B include respective latch mechanisms 32A, 32B with release tabs as are well known. The sidewalls 30A, 30B also include respective guide slots 34A, 34B that allows for guided pluggable insertion of the module into the host system as is well known. Finally, the sidewalls 30A, 30B include respective screw holes 36A, 36B. Mounting screws (not shown) pass through the two holes 36A, 36B and attach to the respective holes (shown as 37B in FIG. 2) in the side surface of the optical part 14 to provide for attachment and alignment of optical part 14 with respect to the housing 12. The top surface of the optical part 14 provides the top surface of the module 10.

A back connector assembly 38 is integrally formed with the bottom plate 24 (or affixed thereto). The back connector assembly 38 supports the electrical interface 21 (e.g., printed circuit board and multi-pin connector) as described above. A cover (not shown) covers the back connector assembly 38 and the electrical interface 21 supported thereon. The cover is affixed to the back connector assembly 38 by screws that pass through screw holes 39A, 39B and screw into corresponding holes therein.

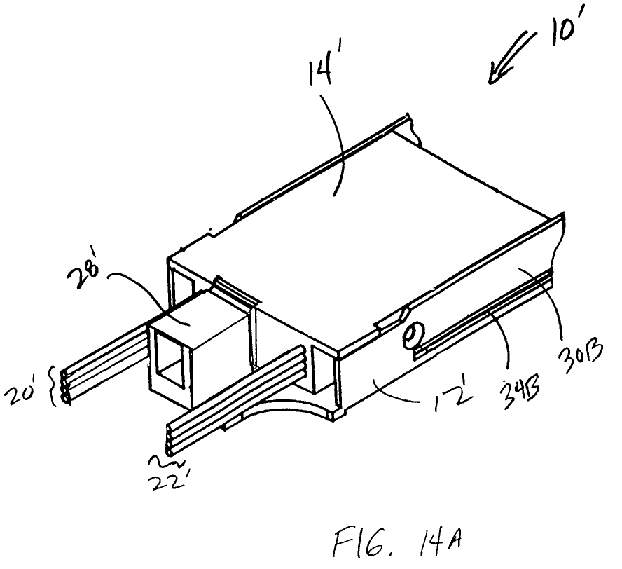

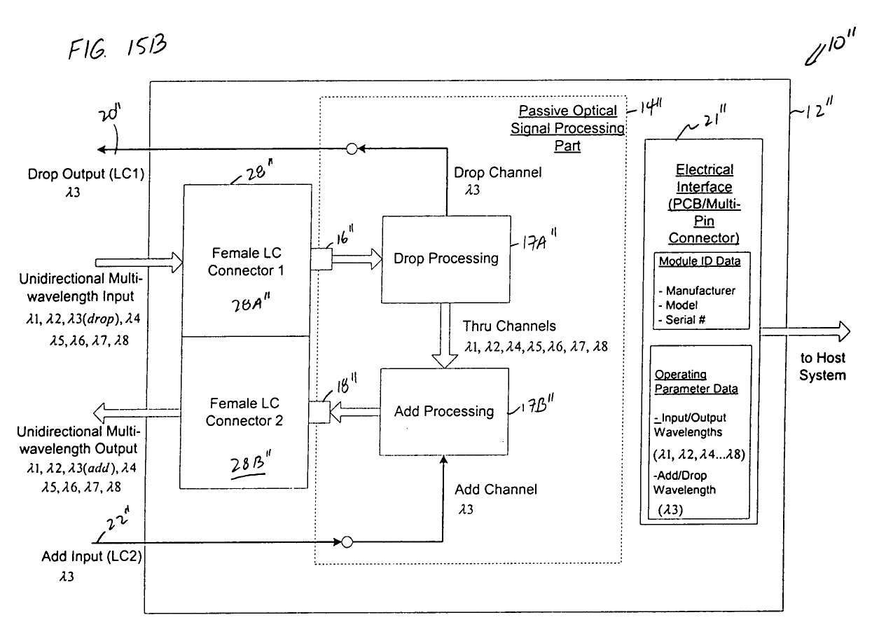

As best shown in FIG. 10, the housing 12 has a total length of total length of 2.774 inches (70.4 mm) and a maximal width of 1.197 inches (30.4 mm). As best shown in FIG. 13, the walls 30A, 30B of the housing 12 have a maximal height of 0.379 inches (9.6 mm) and the duplex female LC connector 28 has a height of 0.411 inches (10.4 mm). In this manner, the width and height dimensions of the module 10 conform to the GBIC standard.

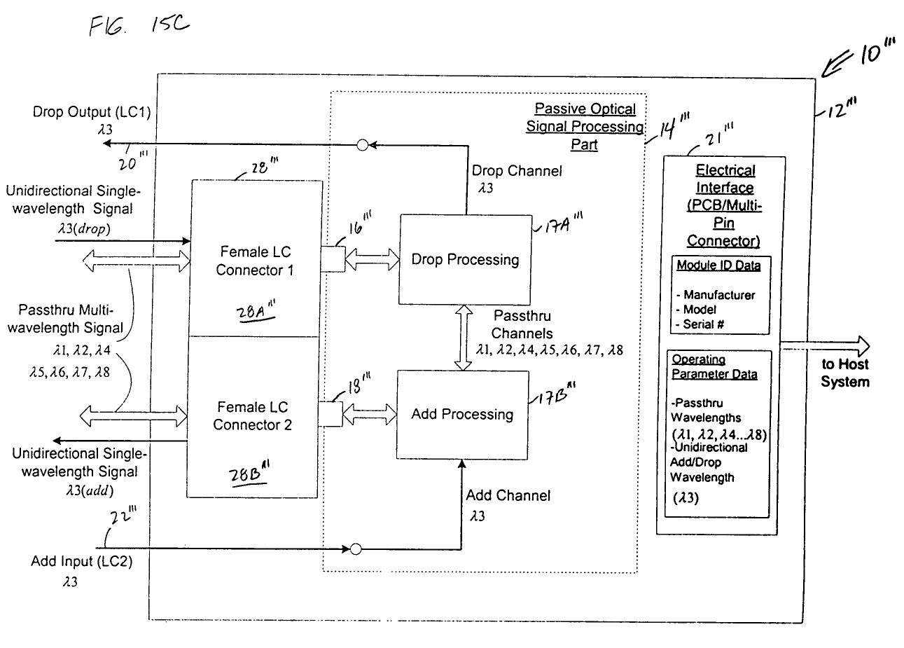

The principles of the present application can be applied to other passive optical signal processing applications. For example, FIGS. 14A and 14B illustrate a small form factor pluggable module 10′ that performs passive demultiplexing and multiplexing operations of optical signals that are carried on a bidirectional fiber link that is interfaced to the module via a single LC connector. The module 10′ employs a housing 12′ and a passive optical signal processing part 14′ that is mounted to the housing 12′. The module 10′ has a maximal width of 1.197 inches (30.4 mm) and a maximal height of 0.411 inches (10.4 mm) such that it conforms to the GBIC standard.

The housing 12′ has a similar mechanical design and dimensions as the housing 12 described above. It supports the single female LC connector 28′, which is aligned to a bidirectional multi-wavelength input/output port 16′ of the passive optical signal processing part 14′. The connector 28′ and the bidirectional multi-wavelength port 16′ receive a unidirectional input multi-wavelength optical signal (i.e., a plurality of wavelength division multiplexed optical signals, for example 4 CWDM wavelengths labeled λ5, λ6, λ7, and λ8) that is supplied by the bidirectional fiber optic link coupled thereto by a male LC optical fiber connector (not shown). The bidirectional multi-wavelength port 16′ and the LC connector 28′ also output a unidirectional output multi-wavelength optical signal (i.e., a plurality of wavelength division multiplexed optical signals, for example the 4 CWDM wavelengths labeled λ1, λ2, λ3, and λ4) for transmission over the bidirectional fiber optic link that is coupled thereto by a male LC optical fiber connector (not shown). The optical part 14′ also includes a set of unidirectional output fiber pigtails 20′ that each carry a different single-wavelength optical signal (i.e., one of the 4 CWDM wavelengths λ5, λ6, λ7, and λ8) that is part of the input multi-wavelength optical signal received at the LC connector 28′ and the bidirectional port 16′. The optical part 14 also includes a set of unidirectional input fiber pigtails 22′ that each carry a different single-wavelength optical signal (i.e., one of the 4 CWDM wavelengths λ1, λ2, λ3, and λ4) that is part of the output multi-wavelength optical signal output by the bidirectional port 16′ and the LC connector 28′.

The passive optical signal processing part 14′ includes optical filter elements (labeled DEMUX Processing 17A′) that are mounted onto a support block (e.g., a polymer bench) and function to demultiplex the input multi-wavelength optical signal received at the connector 28′ and bidirectional port 16′ into its discrete wavelength component signals and direct such wavelength component signals to the respective output fiber pigtails 20′. The passive optical signal processing part 14′ also includes elements (labeled MUX Processing 17B′) that are mounted onto a support block (e.g., a polymer bench) and function to multiplex together the discrete wavelength component optical signals received over the input fiber pigtails 22′ to form a corresponding output multi-wavelength optical signal and direct the output multi-wavelength optical signal to the bidirectional port 16′ and connector 28′ for output therefrom. Examples of the elements that carry out such passive optical demultiplexing and multiplexing operations are described in detail in patent International Patent Publication WO 03/028262, published on Apr. 3, 2003; International Patent Publication WO 2004/044633, published on May 27, 2004; U.S. Pat. No. 6,008,920, issued on Dec. 28, 1999; U.S. Pat. No. 6,292,298, issued on Sep. 18, 2001; and U.S. Pat. No. 5,859,717, issued on Jan. 12, 1999, all incorporated by reference above.

The optical part 14′ is passive in that it does not utilize any opto-electrical components in carrying out the desired optical multiplexing and demultiplexing operations. The dimensions of the optical part 14′ is designed such that it readily fits inside the internal compartment of the housing 12′ as best shown in FIG. 14A.

The small form factor pluggable module 10′ is intended to fit within a slot in a host system (not shown). The housing 12′ of the module 10′ supports an electrical interface 21′ that stores module identification data as well as operational parameter data, and communicates such data to the host system. The module identification data preferably includes data that identifies the manufacturer, model, and/or serial number of the module 10′. The operational parameter data includes data that identifies the operational characteristics of the module 10, such as the wavelengths (e.g., λ5, λ6, λ7, λ8) that are supported by the demultiplexing operations of the optical part 14′ as well as the wavelengths (e.g., λ1, λ2, λ3, λ4) that are supported by the multiplexing operations of the optical part 14′. Such data is useful in maintaining knowledge of and control over the capabilities of the module 10′ as part of the host system. It can readily be accessed by the host system and communicated electronically to a network management system for more efficient and effective inventory control and network configuration verification.

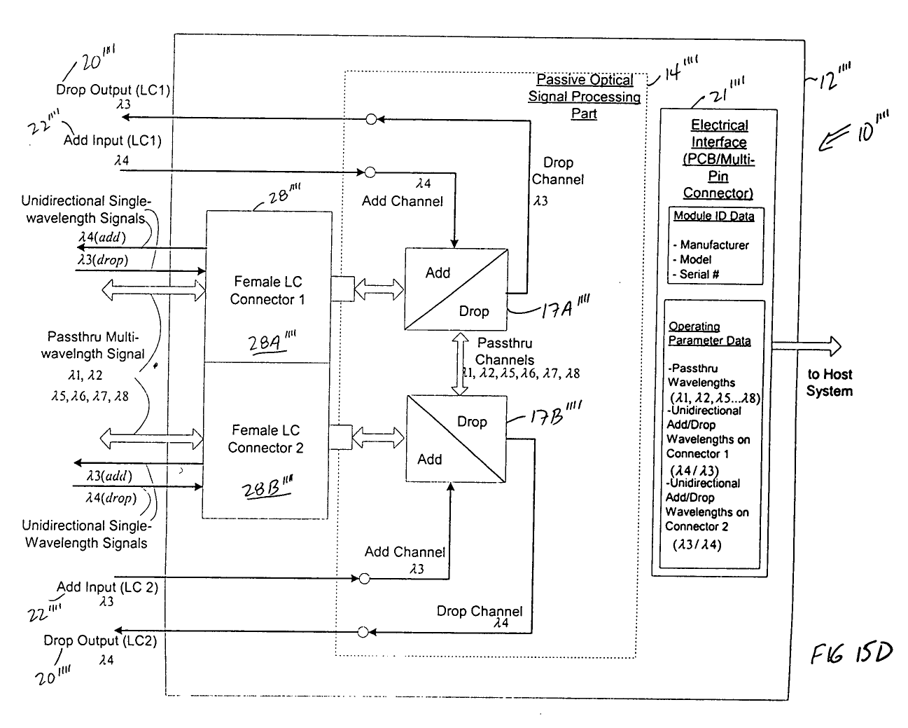

In another example shown in FIGS. 15A and 15B, a small form factor pluggable module 10″ is provided that performs single channel optical add/drop multiplexing of optical signals that are carried on two unidirectional fiber links that are interfaced to the module via a duplex female LC connector. The module 10″ employs a housing 12″ and a passive optical signal processing part 14″ that is mounted to the housing 12″. The module 10″ has a maximal width of 1.197 inches (30.4 mm) and a maximal height of 0.411 inches (10.4 mm) such that it conforms to the GBIC standard.

The housing 12″ has a similar mechanical design and dimensions as the housing 12 described above. It supports a duplex female LC connector 28″, which has a first female LC connector part 28A″ and a second female LC connector part 28B″. The duplex female LC connector 28″ is preferably realized as a one-piece unitary plastic part by molding or other suitable manufacturing techniques. The first connector part 28A″ is aligned to a multi-wavelength input port 16″ of the passive optical signal processing part 14″. The second connector part 28B″ is aligned to a multi-wavelength output port 18″ of the passive optical processing part 14″.

The first connector part 28A″ and the multi-wavelength input port 16″ receive a unidirectional input multi-wavelength optical signal (i.e., a plurality of wavelength division multiplexed optical signals, for example 8 CWDM wavelengths labeled λ1, λ2, λ3 (drop), λ4, λ5, λ6, λ7, and λ8) that is supplied by an “input” fiber optic link that is coupled thereto by a male LC optical fiber connector (not shown). The multi-wavelength output port 18″ and the second connector part 28B output a unidirectional output multi-wavelength optical signal (i.e., a plurality of wavelength division multiplexed optical signals, for example the 8 CWDM wavelengths labeled λ1, λ2, λ3 (add), λ4, λ5, λ6, λ7, and λ8) for transmission over an “output” fiber optic link that is coupled thereto by a male LC optical fiber connector (not shown). One of the wavelengths (e.g., λ3) is designated as the add/drop wavelength. The optical part 14″ includes a unidirectional output fiber pigtail 20″ that carries the drop wavelength optical signal (i.e., λ3 (drop)) that is part of the input multi-wavelength optical signal received at the first connector part 28A″ and input port 16″. The optical part 14″ also includes a unidirectional input fiber pigtail 22″ that carries the add wavelength optical signal (i.e., λ3) that is part of the output multi-wavelength optical signal output at the output port 18″ and the second connector part 28B″.

The passive optical signal processing part 14″ includes optical filter elements (labeled Drop Processing 17A″) that are mounted onto a support block (e.g., a polymer bench) and function to demultiplex the drop wavelength optical signal (i.e., λ3(drop)) from the input multi-wavelength optical signal received at the input port 16″ and directs the drop wavelength optical signal to the output fiber pigtail 20″. The other wavelengths (e.g., λ1, λ2, λ4, λ5, λ6, λ7, and λ8) are passed as part of a multi-wavelength signal (labeled “Thru Channels”) to Add Processing elements 17B″. The Add Processing elements 17B″ are mounted on a support block (e.g., a polymer bench) and function to add/multiplex the add wavelength optical signal (i.e., λ3(add)) received on the input fiber pigtail 22″ to the Thru channel multi-wavelength signal to form a corresponding multi-wavelength optical signal and direct such multi-wavelength optical signal to the multi-wavelength output port 18″ for output therefrom. Examples of the elements that carry out such passive optical demultiplexing and multiplexing operations is described in detail in International Patent Publication WO 03/028262, published on Apr. 3, 2003; International Patent Publication WO 2004/044633, published on May 27, 2004; U.S. Pat. No. 6,008,920, issued on Dec. 28, 1999; U.S. Pat. No. 6,292,298, issued on Sep. 18, 2001; and U.S. Pat. No. 5,859,717, issued on Jan. 12, 1999, all incorporated by reference above.

The optical part 14″ is passive in that it does not utilize any opto-electrical components in carrying out the desired optical multiplexing and demultiplexing operations. The dimensions of the optical part 14″ is designed such that it readily fits inside the internal compartment of the housing 12″ as best shown in FIG. 15A.

The small form factor pluggable module 10″ is intended to fit within a slot in a host system (not shown). The housing 12″ of the module 10″ supports an electrical interface 21″ that stores module identification data as well as operational parameter data, and communicates such data to the host system. The module identification data preferably includes data that identifies the manufacturer, model, and/or serial number of the module 10″. The operational parameter data includes data that identifies the operational characteristics of the module 10″, such as the multi-wavelength pass-through wavelengths (e.g., λ1, λ2, λ4, λ5, λ6, λ7, and λ8) and the add/drop wavelength ((e.g., λ3) supported by the add/drop operations of the optical part 14″. Such data is useful in maintaining knowledge of and control over the capabilities of the module 10″ as part of the host system. It can readily be accessed by the host system and communicated electronically to a network management system for more efficient and effective inventory control and network configuration verification.

In another example shown in FIG. 15C, a small form factor pluggable module 10′″ is provided that performs single channel optical add/drop multiplexing of optical signals that are carried on two fiber links that are interfaced to the module via a duplex female LC connector. The mechanical design and function of the module 10′″ and its elements are similar to that described above with respect to the embodiment of FIGS. 15A and 15B; however, the drop processing elements 17A′″ and the add processing elements 17B′″ are adapted such that the directionality of the pass-through channels (e.g., the pass-through wavelengths λ1, λ2, λ4, λ5, λ6, λ7, and λ8) is arbitrary. Thus, any one (or groups) of the pass-through channels can be i) unidirectional where such channel(s) is (are) input into the first connector part 28A′″ and output from the second connector part 28B′″, ii) unidirectional where such channel(s) is (are) input into the second connector part 28B′″ and output from the first connector part 28A′″, or iii) bidirectional where such channel(s) is (are) input and output from both the first and second connector parts 28A′″, 28B′″. Similar to the embodiment of FIGS. 15A and 15B, the drop wavelength optical signal (e.g., λ3(drop)) is unidirectional and communicated as an input to the first connector 28A′″ and output by the output fiber optic pigtail 20′″, while the add wavelength optical signal (e.g., λ3(add)) is received via the input fiber optic pigtail 22′″ and communicated as a unidirectional output signal over the second connector 28B′″.

In yet another example shown in FIG. 15D, a small form factor pluggable module 10″″ is provided that performs two-channel optical add/drop multiplexing of optical signals that are carried on two fiber links that are interfaced to the module via a duplex female LC connector. The mechanical design and function of the module 10″″ and its elements are similar to that described above with respect to the single channel embodiment of FIG. 15C; however, a second add/drop wavelength (e.g., λ4) is supported by the module. More particularly, the first drop wavelength optical signal (e.g., λ3(drop)) is unidirectional and communicated as an input to the first connector 28A″″ and output by the output fiber optic pigtail 20″″, while the first add wavelength optical signal (e.g., λ3(add)) is received via the input fiber optic pigtail 22″″. The second drop wavelength signal (e.g., λ4(drop)) is received as a unidirectional input signal over the second connector part 28B″″, and thus is interfaced to the complementary connector (e.g., 28B″″) with respect to the connector part 28A″″ which receives the first drop wavelength signal (e.g., λ3(drop)). The optical elements 17B″″ of the module 14″″ are adapted to demultiplex/drop the second drop wavelength signal (e.g., λ4(drop)) from the input optical signal received at the second connector 28B″″ and the port 18″″ and direct the second drop wavelength signal (e.g., λ4(drop)) to its corresponding output fiber optic pigtail 20″″. The second add wavelength signal (e.g., λ4(add)) is received as a unidirectional input signal over a corresponding input fiber optic pigtail 22″″. The optical elements 17A″″ of the module 14″″ are adapted to multiplex/add the second add wavelength signal (e.g., λ4(add)) to the optical signals (if any) output via port 16″″ and the first connector part 28A″″ for output therefrom. In this manner, a second add wavelength signal (e.g., λ4(add)) is output from the complementary connector (e.g., 28A″″) with respect to the connector part 28B″″ which outputs the first add wavelength signal (e.g., λ3(add)).

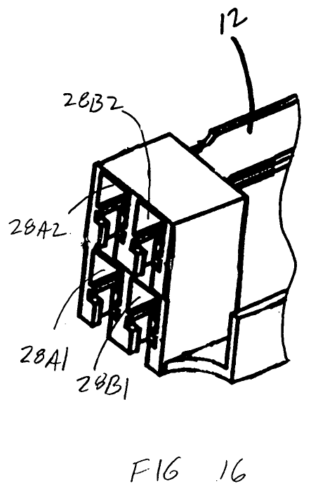

In an alternate configuration shown in FIG. 16, the duplex female LC connector structure of the small form factor pluggable modules described herein can be adapted to extended vertically to include a pair of female duplex LC connector interfaces (28A1, 28A2, 28B1, 28B2) one on top of the other as shown. Alternatively, the pair of duplex female LC connector interfaces may be arranged side by side. Such extended connector structures are particularly useful for the single channel add/drop optical multiplexing applications described above with respect to FIGS. 15A, 15B and 15C. In such applications, the two input/output optical interfaces provided by the pair of fiber optical pigtails are substituted with two corresponding parts of the extended connector structure. The dimensions of the resultant module may be extended beyond the conventional GBIC module dimensions to provide clearance for the extended connector structure. The connector structure may be further extended to include six (or more connectors) for the two-channel optical add drop multiplexing applications as described above with respect to FIG. 15D and the like.

There have been described and illustrated herein several embodiments of a small form factor pluggable module that provides passive optical signal processing of wavelength divisional multiplexed signals. While particular embodiments of the invention have been described, it is not intended that the invention be limited thereto, as it is intended that the invention be as broad in scope as the art will allow and that the specification be read likewise. Thus, while particular applications have been disclosed for CWDM applications, it will be appreciated that the principles of the present invention can be readily extended to DWDM applications as well. In addition, while a particular GBIC-style small form factor module has been disclosed, it will be understood that as the miniaturization of the optical processing elements improves, the principles of the present invention can readily be extended to other small form factor designs, such as SFP or XFP. Moreover, while particular configurations have been disclosed with reference to the electrical interface of the module, it will be appreciated that other configurations could be used as well. For example, the electrical interface can store (and communicate to the host system) a wide variety of information, i.e. wavelength grid information, CLIE codes, and operational parameters of the module (such as required channel spacing, insertion loss information, isolation/directivity information, return loss information). More the principles of the present invention can readily be extended to other passive WDM optical processing applications, such as those applications similar to those described above where one or more unidirectional inputs and/or outputs are substituted with bidirectional inputs and/or outputs. It will therefore be appreciated by those skilled in the art that yet other modifications could be made to the provided invention without deviating from its spirit and scope as claimed.

1. An optical networking device comprising:
a small form factor pluggable housing with a maximum width dimension not greater than 31 mm, the housing supporting an optical subsystem and an electrical interface, said optical subsystem providing passive optical processing of wavelength division multiplexed optical signals, and said electrical interface communicating electrical signals to a host system operably coupled thereto, wherein said electrical signals carry data to the host system.

2. An optical networking device according to claim 1, wherein:
said data comprises module identification data that represents at least one: a manufacturer name; a part number; and a serial number assigned to the device.

3. An optical networking device according to claim 1, wherein:
said data comprises operational parameter data that represents at least one of
i) a plurality of wavelengths that are multiplexed by the device; and
ii) a plurality of wavelengths that are demultiplexed by the device.

4. An optical networking device according to claim 1, wherein:
said data comprises operational parameter data that represents at least one of
i) at least one wavelength that is added by the device; and
ii) at least one wavelength that is dropped by the device.

5. An optical networking device according to claim 1, wherein:
said data comprises operational parameter data that represents at least one wavelength that passes through the device.

6. An optical networking device according to claim 1, wherein:
said housing supports at least one connector structure aligned to a corresponding port of said optical subsystem, said connector structure for interfacing to a fiber optic waveguide that carries a multi-wavelength optical signal processed by said optical subsystem.

7. An optical networking device according to claim 6, further comprising:
at least one input fiber optic pigtail that interfaces to said optical subsystem and that guides a single-wavelength optical signal thereto for processing by said optical subsystem; and
at least one output fiber optic pigtail that interfaces to said optical subsystem and that guides a single-wavelength optical signal generated by said optical subsystem for output therefrom.

8. An optical networking device according to claim 6, wherein:
said housing supports two connectors aligned to corresponding ports of said optical subsystem, said two connectors for interfacing to respective fiber optic waveguides that each carry a multi-wavelength optical signal processed by said optical subsystem.

9. An optical networking device according to claim 8, wherein:
one of said two connectors interfaces to a first fiber optic waveguide that carries an input multi-wavelength signal, and the other of said two connectors interfaces to a second fiber optic waveguide that carries an output multi-wavelength signal.

10. An optical networking device according to claim 9, further comprising:
a plurality of output fiber optic pigtails that interface to said optical subsystem and that each guide a respective single-wavelength optical signal that is generated by said optical subsystem as a result of demultiplexing operations on the input multi-wavelength optical signal, said input multi-wavelength optical signal supplied from the first fiber optic waveguide via its corresponding connector and port; and
a plurality of input fiber optic pigtails that interface to said optical subsystem and that each guide a respective single-wavelength optical signal thereto for optical multiplexing carried out by said optical subsystem, wherein the resultant multi-wavelength signal generated by said optical subsystem is output over the second fiber optic waveguide via its corresponding port and connector.

11. An optical networking device according to claim 6, wherein:
said housing supports a single connector aligned to a corresponding bidirectional port of said optical system, said single connector interfacing to a fiber optic waveguide that carries an input multi-wavelength optical signal and an output multi-wavelength optical signal, said input multi-wavelength optical signal being supplied to said optical subsystem for processing therein and said output multi-wavelength signal being generated by said optical subsystem for output therefrom.

12. An optical networking device according to claim 11, further comprising:
a plurality of output fiber optic pigtails that interface to said optical subsystem and that each guide a respective single-wavelength optical signal generated by said optical subsystem as a result of demultiplexing operations on the input multi-wavelength optical signal, said input multi-wavelength optical signal being input via said single connector and said bidirectional port; and
a plurality of input fiber optic pigtails that interface to said optical subsystem and that each guide a respective single-wavelength optical signal thereto for optical multiplexing carried out by said optical subsystem, wherein the resultant multi-wavelength signal generated by said optical subsystem is output over the fiber optic waveguide via said bidirectional port and said single connector

13. An optical networking device according to claim 7, wherein:
said at least one input fiber optic pigtail guides a single-wavelength optical signal that is added by said optical subsystem to an output optical signal output from said device; and
said at least one output fiber optic pigtail guides a single-wavelength optical signal that is dropped by said optical subsystem from an input optical signal supplied to said device.

14. An optical networking device according to claim 13, wherein:
said housing supports first and second connectors that are aligned with corresponding first and second ports of said optical system, said first and second connectors for interfacing to respective first and second fiber optic waveguides;
wherein said input optical signal is carried over the first fiber optic waveguide and supplied to said optical subsystem via said first connector and said first port; and
wherein said output optical signal is generated by optical subsystem and output to the second fiber waveguide via said second port and said second connector.

15. An optical networking device according to claim 14, wherein:
said first fiber optic waveguide carries an input multi-wavelength signal and said second fiber optic waveguide carries an output multi-wavelength signal.

16. An optical networking device according to claim 14, wherein:
said first and second fiber optic waveguides carry bidirectional multi-wavelength signals.

17. An optical networking device according to claim 14, wherein:
said optical subsystem receives at least one input optical signal from said second fiber optic waveguide via said second connector and said second port, and passes said at least one input optical signal to said first port and said first connector such that it is carried as an output optical signal over said first fiber optic waveguide.

18. An optical networking device according to claim 17, wherein:
said optical subsystem is adapted to bidirectionally pass a plurality of different single-wavelength optical signals.

19. An optical networking device according to claim 13, further comprising:
a second input fiber optic pigtail that guides another single-wavelength optical signals that is added by said optical subsystem to an output optical signal output from said device; and
a second output fiber optic pigtail guides another single-wavelength optical signal that is dropped by said optical subsystem from an input optical signal supplied to said device.

20. An optical networking device according to claim 6, wherein:
said at least one connector structure comprises at least one female LC connector.

21. An optical networking device according to claim 20, wherein:
said at least one connector structure comprises a duplex female LC connector.

22. An optical networking device according to claim 21, wherein:
said duplex female LC connector is realized as a unitary part.

23. An optical networking device according to claim 1, wherein:
said electrical interface employs a low bandwidth communication link for communication to said host system.

24. An optical networking device according to claim 23, wherein:
said low bandwidth communication link is one of an I²C link, an RS-232 link, and an ethernet 10/100 link.

25. An optical networking device according to claim 1, wherein:
said housing further comprises a guide slot and locking mechanism that is used to mechanically support and lock said device into place when it is plugged into a slot of said host system.

26. An optical networking device according to claim 1, wherein:
said wavelength division multiplexed optical signals comprise course wavelength division multiplexed signals with 20 nm spacing between wavelengths in a range 1310 nm to 1610 nm.

27. An optical networking device according to claim 1, wherein:
said wavelength division multiplexed optical signals comprise dense wavelength division multiplexed signals with spacing of 100 GHz or 200 GHz between wavelengths in a range from 1500 nm to 1600 nm.

28. An optical networking device according to claim 1, wherein:
said device comprises a GBIC module.

29. An optical networking device according to claim 1, wherein:
said device comprises an SFP module.

30. An optical networking device according to claim 1, wherein:
said device comprises an XFP module.
